(19) United States
(12) Patent Application Publication
(10) Pub. No.: US 2015/0096236 A1
(43) Pub. Date: Apr. 9, 2015

(54) DOOR OPENER

(71) Applicant: Elias IBRAHIM, Ottawa (CA)

(72) Inventor: Elias IBRAHIM, Ottawa (CA)

(21) Appl. No.: 14/048,204

(22) Filed: Oct. 8, 2013

(51) Int. Cl. E05B 1/00; A47B 95/02

(52) U.S. Cl. CPC E05B 1/0053; A47B 95/02; E05B 1/0015; E05B 1/0069
USPC 49/506; 16/413

(57) ABSTRACT

A door opener includes a base section with a pull structure on a first side thereof and a U-shaped mounting structure on an opposite second side. The mounting structure has a first engaging surface and a second engaging surface spaced-apart from and facing the first engaging surface. A distance between the engaging surfaces proximate the base section corresponds to a distance between a front face and a back face of the door. The door opener is press-fit onto an edge of the door such that the first and second engaging surfaces frictionally engage the front and back surfaces of the door, and such that the pull structure is disposed in-line with and extends away from the edge of the door. During use, a user uses a part of an arm or a leg to pull the pull structure in a direction along which the door opens, thereby opening the door.

### FIELD OF THE INVENTION

The invention relates generally to a door opener, and more particularly to a device for attaching to and opening doors, including cabinet doors in kitchens and various other areas.

### BACKGROUND OF THE INVENTION

Cabinets for kitchens and various other areas typically include a handle by which sliding and hinged (swinging) cabinet doors are opened. Prior art handles require the user to grasp and pull the handle with his or her hands, and in particular require the user to contact the handle with his or her fingers. This operation can be difficult if the user's hands are full, and it is undesirable if the user's hands are soiled, as is often the case when cooking or trying to access slide-out garbage or recycling bins that are built into a cabinet. Further, a temporary or permanent physical disability can make it very difficult for a user to grasp a conventional handle. In particular, a user that has had a limb amputated or that must wear a cast or prosthetic device may find it difficult or impossible to open doors that are equipped with only the prior art handles.

Various solutions for pulling open a door have been suggested. In U.S. Pat. No. 7,043,799, issued on May 16, 2006, Moody discloses a sanitary door opener that is mounted along the lower edge of an entry door in a bathroom or other area where a user washes his or her hands and then wishes to leave without touching a door handle. To this end, the door opener is designed to be operated using the upper surface of the foot. There are a number of disadvantages associated with this device and which makes it unsuitable for use with cabinet doors. In particular, the opener is affixed to the door using screws that penetrate into the surface of the door causing damage thereto. Further, the door opener wraps around the lower edge of the door so that the portion that is engaged by the user's toe is positioned at a height that is several inches above the lower edge of the door. This arrangement does not present significant disadvantages when the opener is used for its intended purpose and is attached to an entry door, since the user must lift his or her foot only a few inches off the ground in order to pull open the door. However, base cabinets in kitchens typically are raised several inches above the floor surface. As such, the user might be required to lift his or her foot by 8-10 inches in order to pull open a base cabinet door using Moody's door opener, thereby requiring excellent balance and coordination. Of course, the door opener that is described by Moody is even less suitable for use with upper cabinets in kitchens and various other areas. In that case, the user would be forced to grip the door opener with his or her fingers in exactly the same way that a conventional handle is used.

In U.S. Pat. No. 4,817,239, issued on Apr. 4, 1989, Campbell et al. disclose a sanitary door opening assembly comprising a U-shaped bracket and a hook that is mounted to the bracket and to a door using fasteners, such as screws. The hook is located on the inward side of the door at a convenient location between the waist and chest height. To operate, a user places his or her forearm into the concave pocket of the hook and pulls the door in the direction of the door swing. The individual passes through the doorway, and easily removes his or her forearm from the hook since the concave pocket of the hook faces toward the outer swinging edge of the door. More particularly, the assembly that is disclosed by Campbell et al. supports a swift and unrestricted exit since the forearm will naturally disengage from the hook as the individual walks through the doorway. Unfortunately, this assembly also causes damage to the surface of the door to which it is mounted. Further, if mounted for use with cabinet doors in kitchens and various other areas the assembly would require the user to bend and/or stretch in order to engage the U-shaped hook with his or her forearm. Clearly, this assembly is not suitable for use with cabinets in kitchens and various other areas.

In U.S. Pat. No. 6,382,750, issued on May 7, 2002, King discloses hardware for opening a cabinet door. The hardware is a curved plate with one end that is adapted to be screw-mounted to the surface of the door and an opposite end that is adapted to project downwardly and outwardly away from the surface of the door, so that it extends below the lower edge thereof. The hardware that is disclosed by King is readily accessible with the foot of a user, and enables the door to be opened without the use of hands. Unfortunately, the hardware is screw-mounted and therefore causes permanent damage to the surface of the door to which it is mounted. Further, the hardware projects downward and outward away from the surface of the door, and therefore poses an injury hazard to the lower legs of the user.

None of the known solutions is capable of being used without causing damage to the surface of the door that is to be opened. Further, none of the known solutions is capable of being moved from door to door in a convenient manner, including the doors of base cabinets and upper cabinets, as required. Further still, none of the known solutions provides a door opener that can be used reliably by individuals with temporary or permanent physical disabilities affecting one or more of their limbs. It would therefore be beneficial to provide a system and method that overcomes at least some of the above-mentioned limitations and disadvantages of the prior art.

### SUMMARY OF THE INVENTION

In accordance with an aspect of the invention, there is provided a door opener for attaching to and opening a door, the door opener comprising: a U-shaped mounting portion having two legs extending in a same first direction away from a first side of a base section, the two legs and the first side of the base section cooperating to form a channel with an opening for receiving an edge of the door, each one of the two legs including an inner and an outer face, the inner faces of the legs being disposed in a spaced-apart facing relationship one relative to the other; and a pull structure protruding from a second side of the base section that is opposite the first side, the pull structure extending away from the second side of the base section in a second direction that is opposite the first direction, wherein the two legs are inclined one toward the other when the door opener is in a detached condition, such that a distance between the inner faces of the legs as measured at the opening is less than a distance between the inner faces of the legs as measured at the base section, and wherein the legs are displaced outwardly one away from the other when the door opener is in an attached condition and the edge of the door is received within the channel, so that the inner faces of the legs frictionally engage opposite surfaces of the door proximate to said edge.

In accordance with an aspect of the invention, there is provided a door opener for attaching to and opening a door, the door opener comprising: a base section comprising a pull structure formed on one side thereof; and a front leg extending away from a front edge of said base section and a back leg extending away from a back edge of said base section, the front leg having a first engaging surface and the back leg having a second engaging surface, the first engaging surface being spaced-apart from and facing the second engaging surface, a distance between the first engaging surface and the second engaging surface measured at the base section corresponding to a distance between a front face and a back face of said door proximate an edge thereof; wherein, when the door opener is attached to said door proximate said edge thereof, the first engaging surface frictionally engages the front surface of said door and the second engaging surface frictionally engages the back surface of said door, and said pull structure is disposed in-line with and extends away from said edge of said door.

In accordance with an aspect of the invention, there is provided a method of opening a door having a lower edge and front and back vertical surfaces, comprising: providing a door opener, the door opener comprising: a base section comprising a pull structure formed on one side thereof; and a front leg extending away from a front edge of said base section and a back leg extending away from a back edge of said base section, the front leg having a first engaging surface and the back leg having a second engaging surface, the first engaging surface being spaced-apart from and facing the second engaging surface, a distance between the first engaging surface and the second engaging surface as measured at the base section corresponding to a distance between the front surface and the back surface of said door proximate said lower edge thereof; releasably mounting the door opener to the door along said lower edge thereof, comprising: aligning the lower edge of the door between the front leg and the back leg of the door opener; and pressing the door opener in a direction toward the edge of the door, so that the front leg and the back leg of the door opener are deformed outwardly apart one relative to the other, and so that the first engaging surface frictionally engages the front surface of said door, the second engaging surface frictionally engages the back surface of said door, and said pull structure is disposed in-line with and extends downwardly away from said edge of said door; and using a part of an arm or a leg, other than a finger, contacting the pull structure and pulling the pull structure in a direction along which the door opens

### BRIEF DESCRIPTION OF THE DRAWINGS

The embodiments of the instant invention will now be described by way of example only, and with reference to the attached drawings, wherein similar reference numerals denote similar elements throughout the several views, and in which:

FIG. 1A is a top view of a door opener according to an embodiment.

FIG. 1B is an end view of the door opener of FIG. 1A.

FIG. 1C is a side view of the door opener of FIG. 1A.

FIG. 1D is a bottom view of the door opener of FIG. 1A.

FIG. 2A is a top view of another door opener according to an embodiment.

FIG. 2B is an end view of the door opener of FIG. 2A.

FIG. 2C is a side view of the door opener of FIG. 2A.

FIG. 2D is a bottom view of the door opener of FIG. 2A.

FIG. 3A is a top view of still another door opener according to an embodiment.

FIG. 3B is an end view of the door opener of FIG. 3A.

FIG. 3C is a side view of the door opener of FIG. 3A.

FIG. 3D is a bottom view of the door opener of FIG. 3A.

FIG. 4A is a side view of yet another door opener, which is similar to the door opener shown in FIG. 3A, but which has rounded edges.

FIG. 4B is a top view of the door opener of FIG. 4A.

FIG. 5 is a cross-sectional end view showing a door opener according to an embodiment, and having a void-space defined within the pull portion thereof.

FIG. 6 is an end view showing a door opener according to an embodiment, in which the front and back legs have generally planar, inner facing surfaces.

FIG. 7 is a simplified diagram showing the door opener of FIGS. 1A-D mounted at a lower edge of a door.

FIG. 8 is a simplified diagram showing the door opener of FIGS. 1A-D mounted at a lower edge of a door and being engaged by the forearm of a user.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

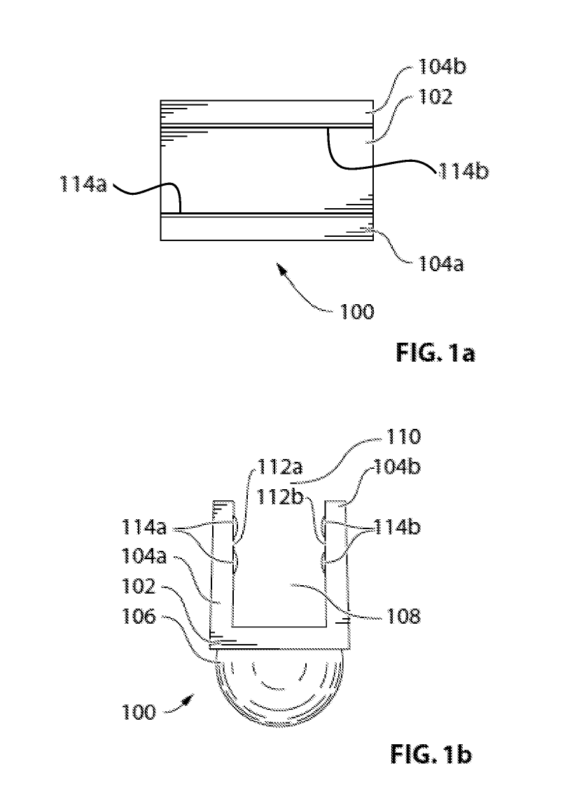

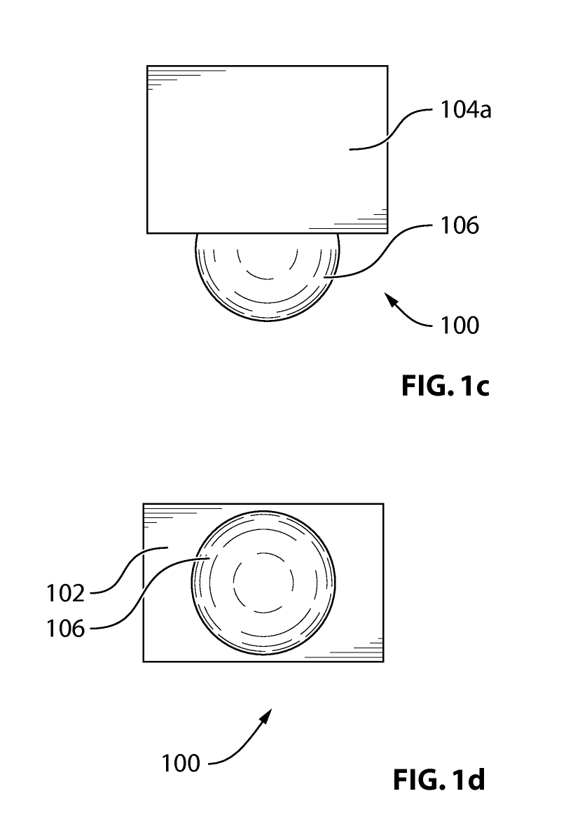

Referring to FIGS. 1A-D, shown are a top view, an end view, a side view and a bottom view, respectively, of a door opener 100 according to an embodiment. With reference specifically to FIGS. 1A and 1B, the door opener 100 includes a base section 102, two legs including a front leg 104a and a back leg 104b, and a pull structure 106. The front leg 104a, the base section 102 and the back leg 104b cooperate to define a generally U-shaped mounting portion forming a channel 108 with an opening 110 for receiving an edge of a door that is to be opened.

As is shown best in FIG. 1B, each one of the two legs has an inner and an outer face, the inner faces 112a and 112b of the legs 104a and 104b, respectively, being disposed in a spaced-apart facing relationship one relative to the other. More particularly, the legs 104a and 104b are inclined one toward the other such that a distance between the inner faces 112a and 112b as measured at the opening 110 is less than a distance between the inner faces 112a and 112b as measured at the base section 102. In this way, when the door opener is mounted to a door so that an edge of the door is received within the channel 108, the legs 104a and 104 are displaced outwardly one away from the other and the inner faces thereof 112a and 112b frictionally engage opposite front and back surfaces, respectively, of the door. In the specific example that is shown in FIGS. 1A-D a pair of ridge structures 114a is provided along the inner face 112a of the front leg 104a and a pair of ridge structure 114b is provided along the inner face 112b of the back leg 104b. The ridges of the pairs of ridge structures 114a and 114b are substantially aligned in a facing relationship, and assist in guiding the door opener onto the edge of the door and subsequently retaining the door opener at said edge. Optionally, the inner faces 112a and 112b are generally planar, or support other structures for guiding and retaining the door opener during mounting to the door. As one of ordinary skill in the art will immediately appreciate, no mechanical fasteners (screws, nuts and bolts etc.) or adhesives (glue, epoxy etc.) are used to mount the door opener 100 to a door. Rather, the door opener is simply aligned with an edge of the door and then press-fit into place. Optionally, a non-slip finish is provided along the inner faces 112a and 112b, as well as along the ridge structures 114a and 114b if present. The non-slip finish prevents accidental removal of the door opener from the door while at the same time allowing the user to remove the door opener so that it may be cleaned, stored or even mounted to a different door.

As is known in the art, doors for cabinets in kitchens and various other areas are available in a variety of thicknesses, with typical values ranging from ½-inch to ¾-inch. Different sizes of door openers may therefore be produced, with a distance between the inner faces 112a and 112b, as measured at the base section, corresponding to the different standard door thicknesses. The front leg 104a and back leg 104b are sufficiently flexible such that, when being mounted to a door of corresponding thickness, the opening 110 expands to accommodate and receive the edge of the door into the channel 108.

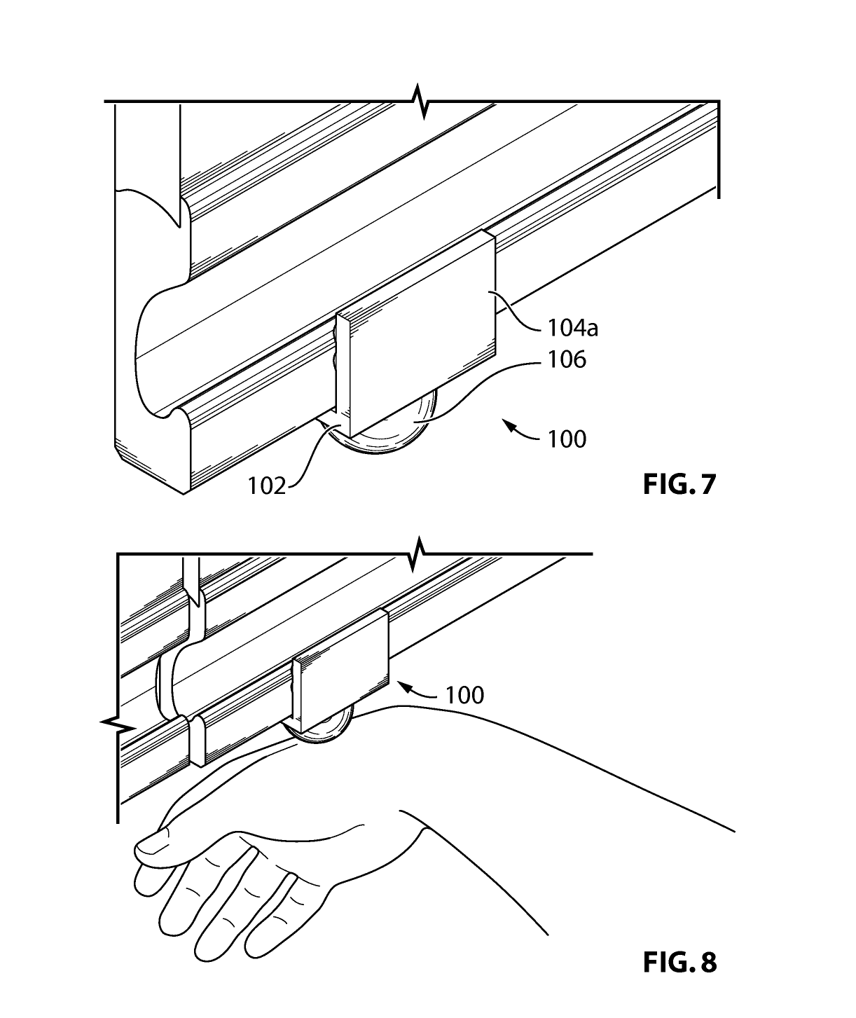

With particular reference to FIGS. 1B-1D, the door opener further includes a pull structure 106. The pull structure 106 protrudes from the base section 102 in a direction opposite the legs 104a and 104b. Further, the pull structure 106 is formed on a side of the base section 102 opposite the legs 104a and 104b. In the specific and non-limiting example that is shown in FIGS. 1B-1D, the pull structure 106 is a portion of a sphere. During use, the door opener is mounted along preferably the bottom edge of a door of either a base cabinet or an upper cabinet in a kitchen or various other areas. In particular, the generally U-shaped mounting portion that is defined by the front leg 104a, the base section 102 and the back leg 104b “clamps” onto the door proximate the edge thereof, such that the inner faces 112a and 112b, and/or the ridge structures 114a and 114b, frictionally engage opposite front and back surfaces of the door, respectively. The pull portion is thus disposed in-line with and extends away from the edge of the door. When the door opener 100 is mounted to the lower edge of the door, as is shown in more detail in FIG. 7, the pull portion 106 projects downward and is in-line with the edge of the door. As such, the pull portion 106 is well positioned to be engaged by the back of a user's hand, by the user's forearm, etc. when mounted to the door of an upper cabinet, as shown in FIG. 8. Alternatively, the pull portion 106 is well positioned to be engaged by the top of a user's foot or by a user's toe, etc. when mounted to the door of a base cabinet. With particular reference to FIG. 7, the door opener does not project outwardly from the front surface of the door, and so it does not present an injury hazard. Further, mounting the door opener too the door does not result in any damage to the front or back surface of the door. Preferably, the pull portion 106 also has a non-slip finish.

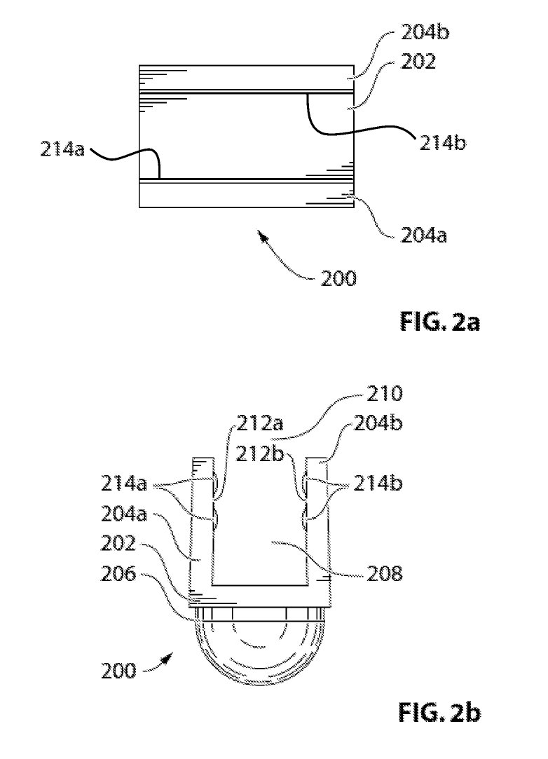

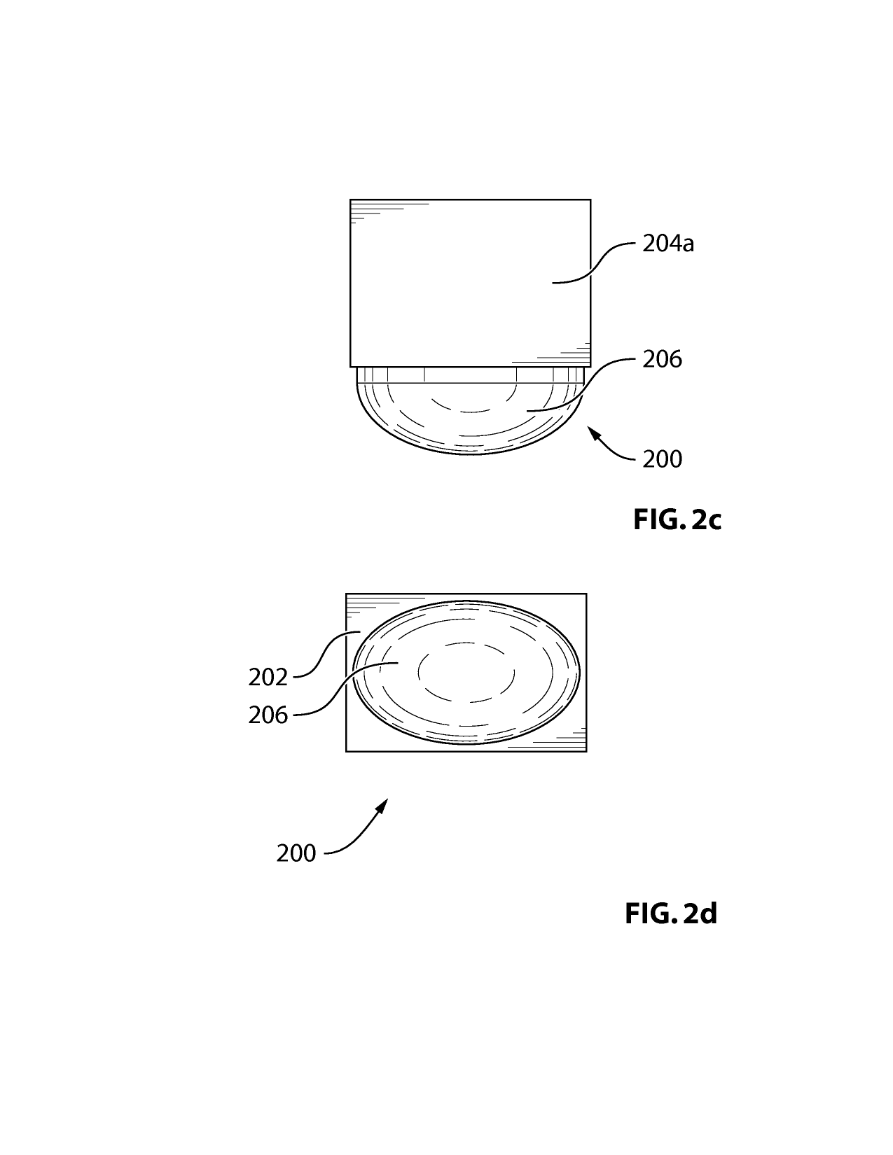

Referring to FIGS. 2A-D, shown are a top view, an end view, a side view and a bottom view, respectively, of another door opener 200 according to an embodiment. With reference specifically to FIGS. 2A and 2B, the door opener 200 includes a base section 202, two legs including a front leg 204a and a back leg 204b, and a pull structure 206. The front leg 204a, the base section 202 and the back leg 204b cooperate to define a generally U-shaped mounting portion forming a channel 208 with an opening 210 for receiving an edge of a door that is to be opened.

As is shown best in FIG. 2B, each one of the two legs has an inner and an outer face, the inner faces 212a and 212b of the legs 204a and 204b, respectively, being disposed in a spaced-apart facing relationship one relative to the other. More particularly, the legs 204a and 204b are inclined one toward the other such that a distance between the inner faces 212a and 212b as measured at the opening 210 is less than a distance between the inner faces 212a and 212b as measured at the base section 202. In this way, when the door opener is mounted to a door so that an edge of the door is received within the channel 208, the legs 204a and 204 are displaced outwardly one away from the other and the inner faces thereof 212a and 212b frictionally engage opposite front and back surfaces, respectively, of the door. In the specific example that is shown in FIGS. 2A-D a pair of ridge structures 214a is provided along the inner face 212a of the front leg 204a and a pair of ridge structure 214b is provided along the inner face 212b of the back leg 204b. The ridges of the pairs of ridge structures 214a and 214b are substantially aligned in a facing relationship, and assist in guiding the door opener onto the edge of the door and subsequently retaining the door opener at said edge. Optionally, the inner faces 212a and 212b are generally planar, or support other structures for guiding and retaining the door opener during mounting to the door. As one of ordinary skill in the art will immediately appreciate, no mechanical fasteners (screws, nuts and bolts etc.) or adhesives (glue, epoxy etc.) are used to mount the door opener 200 to a door. Rather, the door opener is simply aligned with an edge of the door and then press-fit into place. Optionally, a non-slip finish is provided along the inner faces 212a and 212b, as well as along the ridge structures 214a and 214b if present. The non-slip finish prevents accidental removal of the door opener from the door while at the same time allowing the user to remove the door opener so that it may be cleaned, stored or even mounted to a different door.

As is known in the art, doors for cabinets in kitchens and various other areas are available in a variety of thicknesses, with typical values ranging from ½-inch to ¾-inch. Different sizes of door openers may therefore be produced, with a distance between the inner faces 212a and 212b, as measured at the base section, corresponding to the different standard door thicknesses. The front leg 204a and back leg 204b are sufficiently flexible such that, when being mounted to a door of corresponding thickness, the opening 210 expands to accommodate and receive the edge of the door into the channel 208.

With particular reference to FIGS. 2B-2D, the door opener 200 further includes a pull structure 206. The pull structure 206 protrudes from the base section 202 in a direction opposite the legs 204a and 204b. Further, the pull structure 206 is formed on a side of the base section 202 opposite the legs 204a and 204b. In the specific and non-limiting example that is shown in FIGS. 2B-2D, the pull structure 206 is a portion of an ovoid. During use, the door opener 200 is mounted along preferably the bottom edge of a door of either a base cabinet or an upper cabinet in a kitchen or various other areas. In particular, the generally U-shaped mounting portion that is defined by the front leg 204a, the base section 202 and the back leg 204b “clamps” onto the door proximate the edge thereof, such that the inner faces 212a and 212b, and/or the ridge structures 214a and 214b, frictionally engage opposite front and back surfaces of the door, respectively. The pull portion 206 is thus disposed in-line with and extends away from the edge of the door. In a manner similar to that which is discussed supra with reference to the door opener 100 in FIG. 7, the pull portion 206 projects downward and is in-line with the bottom edge of a door. As such, the pull portion 206 is also well positioned to be engaged by the back of a user's hand, by the user's forearm, etc. when mounted to the door of an upper cabinet. Alternatively, the pull portion 206 is also well positioned to be engaged by the top of a user's foot or by a user's toe, etc. when mounted to the door of a base cabinet. The door opener 200 does not project outwardly from the front surface of the door, and so it does not present an injury hazard. Further, mounting the door opener 200 to the door does not result in any damage to the front or back surface of the door. Preferably, the pull portion 206 also has a non-slip finish.

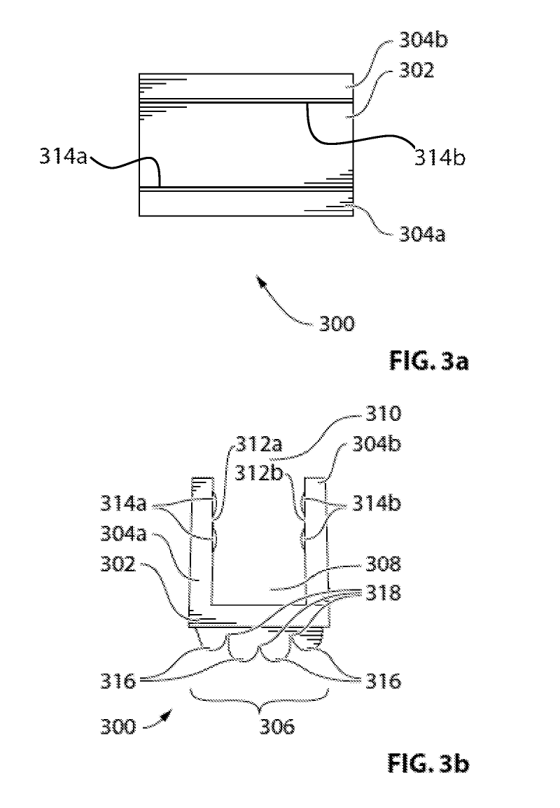

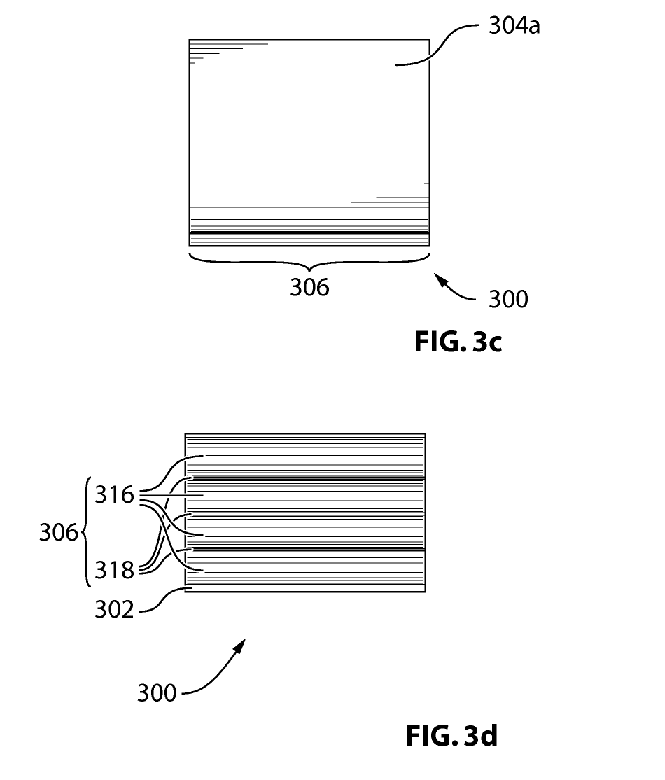

Referring to FIGS. 3A-D, shown are a top view, an end view, a side view and a bottom view, respectively, of still another door opener 300 according to an embodiment. With reference specifically to FIGS. 3A and 3B, the door opener 300 includes a base section 302, two legs including a front leg 304a and a back leg 304b, and a pull structure 306. The front leg 304a, the base section 302 and the back leg 304b cooperate to define a generally U-shaped mounting portion forming a channel 308 with an opening 310 for receiving an edge of a door that is to be opened.

As is shown best in FIG. 3B, each one of the two legs has an inner and an outer face, the inner faces 312a and 312b of the legs 304a and 304b, respectively, being disposed in a spaced-apart facing relationship one relative to the other. More particularly, the legs 304a and 304b are inclined one toward the other such that a distance between the inner faces 312a and 312b as measured at the opening 310 is less than a distance between the inner faces 312a and 312b as measured at the base section 302. In this way, when the door opener is mounted to a door so that an edge of the door is received within the channel 308, the legs 304a and 304 are displaced outwardly one away from the other and the inner faces thereof 312a and 312b frictionally engage opposite front and back surfaces, respectively, of the door. In the specific example that is shown in FIGS. 3A-3D a pair of ridge structures 314a is provided along the inner face 312a of the front leg 304a and a pair of ridge structure 314b is provided along the inner face 312b of the back leg 304b. The ridges of the pairs of ridge structures 314a and 314b are substantially aligned in a facing relationship, and assist in guiding the door opener onto the edge of the door and subsequently retaining the door opener at said edge. Optionally, the inner faces 312a and 312b are generally planar, or support other structures for guiding and retaining the door opener during mounting to the door. As one of ordinary skill in the art will immediately appreciate, no mechanical fasteners (screws, nuts and bolts etc.) or adhesives (glue, epoxy etc.) are used to mount the door opener 300 to a door. Rather, the door opener is simply aligned with an edge of the door and then press-fit into place. Optionally, a non-slip finish is provided along the inner faces 312a and 312b, as well as along the ridge structures 314a and 314b if present. The non-slip finish prevents accidental removal of the door opener from the door while at the same time allowing the user to remove the door opener so that it may be cleaned, stored or even mounted to a different door.

As is known in the art, doors for cabinets in kitchens and various other areas are available in a variety of thicknesses, with typical values ranging from ½-inch to ¾-inch. Different sizes of door openers may therefore be produced, with a distance between the inner faces 312a and 312b, as measured at the base section, corresponding to the different standard door thicknesses. The front leg 304a and back leg 304b are sufficiently flexible such that, when being mounted to a door of corresponding thickness, the opening 310 expands to accommodate and receive the edge of the door into the channel 308.

With particular reference to FIGS. 3B-3D, the door opener 300 further includes a pull structure 306. The pull structure 306 protrudes from the base section 302 in a direction opposite the legs 304a and 304b. Further, the pull structure 306 is formed on a side of the base section 302 opposite the legs 304a and 304b. In the specific and non-limiting example that is shown in FIGS. 3B-3D, the pull structure 306 comprises a plurality of parallel ridge-structures 316 extending along the length of the base section 302. A valley 318 separates adjacent ones of the ridge structures 316. During use, the door opener 300 is mounted along preferably the bottom edge of a door of either a base cabinet or an upper cabinet in a kitchen or various other areas. In particular, the generally U-shaped mounting portion that is defined by the front leg 304a, the base section 302 and the back leg 304b “clamps” onto the door proximate the edge thereof, such that the inner faces 312a and 312b, and/or the ridge structures 314a and 314b, frictionally engage opposite front and back surfaces of the door, respectively. The pull portion is thus disposed in-line with and extends away from the edge of the door. In a manner similar to that which is discussed supra with reference to the door opener 100 in FIG. 7, the pull portion 306 projects downward and is in-line with the bottom edge of a door. As such, the pull portion 306 is also well positioned to be engaged by the back of a user's hand, by the user's forearm, etc. when mounted to the door of an upper cabinet. Alternatively, the pull portion 306 is also well positioned to be engaged by the top of a user's foot or by a user's toe, etc. when mounted to the door of a base cabinet. The door opener 300 does not project outwardly from the front surface of the door, and so it does not present an injury hazard. Further, mounting the door opener 300 to the door does not result in any damage to the front or back surface of the door. Preferably, the pull portion 306 also has a non-slip finish.

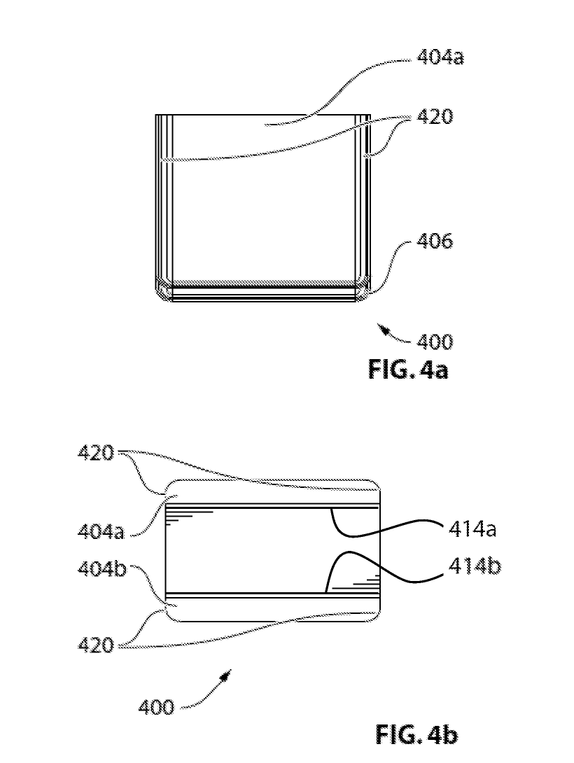

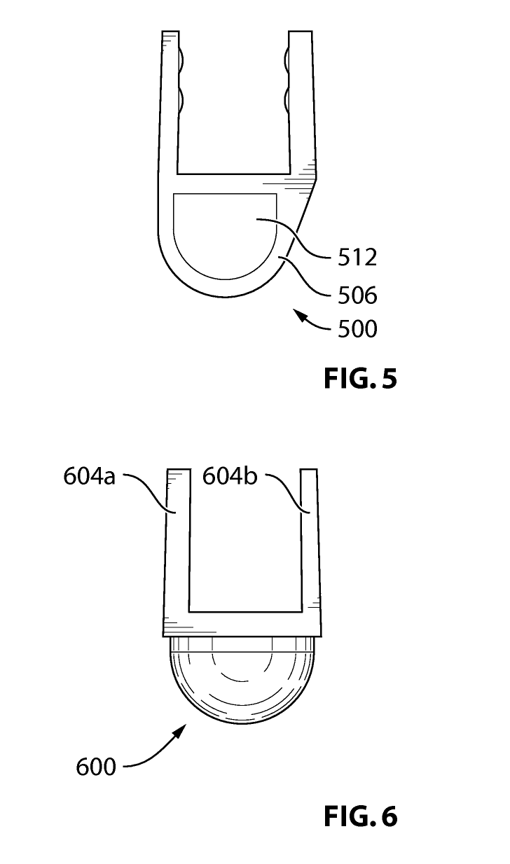

The door openers 100, 200 and 300 are susceptible to a variety of modifications of shape and finish, without departing from the scope of the present invention. For instance, as shown in FIGS. 4A and 4B, the door opener 400 is a modified form of the door opener 300 in which the front and back legs 404a and 404b, respectively, have rounded or curved edges 420. Rounded or curved edges reduce the chance of the user scratching himself or herself during use. Similar modifications may also be made to the door openers 100 or 200, etc. Further, as shown in cross-section in FIG. 5, the pull structure 506 may be hollow or otherwise fabricated with a void region 512, so as to reduce the amount of material that is used to make the door opener 500, or 100, 200, 300 etc. Further still, FIG. 6 shows a modified form of the door opener 100 or 200 having generally planar inner facing surfaces of the front leg 604a and back leg 604b. Similar modifications may also be made to the door openers 100 or 200, etc.

Any of the door openers 100, 200, 300, 400, 500 and 600 may be mounted to the doors of either base cabinets or upper cabinets in kitchens or in various other areas. For instance, the door openers may be mounted to doors of cabinets in a work shop or in a garage, allowing the user to open the doors without transferring grease, dirt, paint, etc. to existing door handles. That said, the door opener 300 is best suited for use with the doors of base cabinets. In particular, the parallel ridge structures 316 and valleys 318 of the pull structure 306 are best suited for being pulled using the top of a foot or a toe. On the other hand, the door openers 100 and 200 are well suited for use with doors of upper cabinets or base cabinets, but when used with upper cabinets the spherical or ovoid shape of the pull structure provides a pivot point that facilitate opening of the door when the use pulls with the back of the his or her hand.

In the specific and non-limiting examples that have been described with reference to FIGS. 1-7, the door openers 100, 200, 300, 400, 500 or 600 are formed of a single continuous material. Forming may be accomplished using known molding techniques etc. Suitable materials are rigid but semi-flexible; examples include elastomeric materials such as for instance known thermoset materials or thermoplastic materials. Optionally, the door openers 100, 200, 300, 400, 500 or 600 are formed from separate pieces that are assembled together. By way of a specific and non-limiting example, the front leg, base section and back leg are formed of a single continuous material and the pull structure is formed separately, either from the same material or a different material, and is subsequently permanently attached to the base section. Further optionally, the pull structure is removably attached to the base such that different pull structures may be substituted depending on the user's intended use of the door opener.

A method of opening a door having a lower edge and front and back vertical surfaces comprises providing a door opener, such as for instance one of the door openers 100, 200, 300, 400, 500 or 600. The provided door opener is then releasably mounted to the door along said lower edge thereof. In particular, the lower edge of the door is aligned between the front leg and the back leg of the door opener, and the door opener is subsequently pressed in a direction toward the edge of the door. In this way, the front leg and the back leg of the door opener are deformed outwardly apart, one relative to the other, and the inner faces (i.e., engaging surfaces) of the front and back legs frictionally engage the front and back vertical surfaces of the door. Further, the pull structure is disposed in-line with, and extends downwardly away from, the lower edge of the door. Once so mounted, the user uses a part of an arm or a leg, other than a finger, to contact the pull structure, and pulls the pull structure in a direction along which the door opens.

Numerous other embodiments may be envisaged without departing from the scope of the present invention.

1. A door opener for attaching to and opening a cabinet door, the door opener comprising:
a U-shaped mounting portion having two legs extending in a same first direction away from a first side of a base section, the two legs and the first side of the base section cooperating to form a channel with an opening for receiving an edge of the door, each one of the two legs including an inner and an outer face, the inner faces of the legs being disposed in a spaced-apart facing relationship one relative to the other; and
a pull structure protruding from a second side of the base section that is opposite the first side, the pull structure extending away from the second side of the base section in a second direction that is opposite the first direction, and the pull structure having an ellipsoid-shaped outer engagement surface,
wherein the two legs are inclined one toward the other when the door opener is in a detached condition, such that a distance between the inner faces of the legs as measured at the opening is less than a distance between the inner faces of the legs as measured at the base section, and
wherein the legs are displaced outwardly one away from the other when the door opener is in an attached condition and the edge of the cabinet door is received within the channel, so that the inner faces of the legs frictionally engage opposite surfaces of the cabinet door proximate to said edge.

2. The door opener of claim 1, wherein a distance between the inner faces of the legs as measured at the opening is substantially equal to the distance between the inner faces of the legs as measured at the base section when the door opener is in the attached condition and the edge of the door is received within the channel.

3. The door opener of claim 1, wherein the distance between the inner faces of the legs as measured at the base section is substantially equal to a thickness of the cabinet door as measured between the opposite faces at said edge.

4. The door opener of claim 1, wherein the inner faces of the legs are generally planar.

5. The door opener of claim 1, comprising at least one ridge structure protruding from the inner face of each of the legs and extending along in a third direction transverse the first direction.

6. The door opener of claim 1, wherein the inner face of each of the legs has a non-slip finish.

7-9. (canceled)

10. The door opener of claim 1, wherein the pull structure has a non-slip finish.

11. The door opener of claim 1, wherein the base section, the two legs and the pull structure are formed of a single, continuous material.

12. A door opener for attaching to and opening a cabinet door, the door opener comprising:
a base section comprising a pull structure formed on one side thereof, the pull structure extending away from the base section along a first direction and having an ellipsoid-shaped outer engagement surface; and
a front leg extending away from a front edge of said base section and a back leg extending away from a back edge of said base section, the front leg having a first engaging surface and the back leg having a second engaging surface, the first engaging surface being spaced-apart from and facing the second engaging surface, a distance between the first engaging surface and the second engaging surface measured at the base section corresponding to a distance between a front face and a back face of said cabinet door proximate an edge thereof;
wherein, when the door opener is attached to said cabinet door proximate said edge thereof, the first engaging surface frictionally engages the front surface of said cabinet door and the second engaging surface frictionally engages the back surface of said cabinet door, and said pull structure is disposed in-line with and extends away from said edge of said cabinet door.

13. The door opener of claim 12, wherein the first engaging surface and the second engaging surface are generally planar.

14. The door opener of claim 12, comprising at least one ridge structure protruding from the first engaging surface and at least one ridge structure protruding from the second engaging surface.

15. The door opener of claim 12, wherein the first engaging surface and the second engaging surface extend away from the base section, and when the door opener is other than attached to said cabinet door the distance between the first engaging surface and the second engaging surface decreases with increasing distance away from the base section.

16-18. (canceled)

19. The door opener of claim 12, wherein the pull structure has a non-slip finish.

20. The door opener of claim 12, wherein the base section, the front and back legs, and the pull structure are formed of a single, continuous material.

21-24. (canceled)
